(19) United States
(12) Patent Application Publication
(10) Pub. No.: US 2006/0092163 A1
(43) Pub. Date: May 4, 2006

(54) Rendering images on a video graphics adapter

(75) Inventors: Wei Kuo, Austin, TX (US); Neal Richard Marion, Georgetown, TX (US); George Francis Ramsay III, Cedar Park, TX (US); James Stanley Tesauro, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 10/981,266

(22) Filed: Nov. 4, 2004

(51) Int. Cl. G06T 15/00; G06T 1/00

(52) U.S. Cl. 345/522

(57) ABSTRACT

Rendering images on a video graphics adapter, the method including receiving in the video graphics adapter a video graphics command including a window identification (‘WID’) value and simultaneously, in accordance with the video graphics command and in dependence upon the WID value, rendering video frame data to a frame buffer and WID data to a WID buffer. Typical embodiments include configuring the video graphics command to include the WID value. In typical embodiments, the WID value represents an index to a pixel type in a window attribute table.

### BACKGROUND OF THE INVENTION

1. Field of the Invention

The field of the invention is data processing, or, more specifically, methods, systems, and products for rendering images on a video graphics adapter.

2. Description of Related Art

A video graphics adapter (sometimes called simply ‘video adapter’) is a board that plugs into a personal computer to give it display capabilities. The display capabilities of a computer, however, depend on both the logical circuitry (provided in the video adapter) and the display monitor. A monochrome monitor, for example, cannot display colors no matter how powerful the video adapter. Many different types of video adapters are available for computers. Most conform to one of the video standards defined by IBM or VESA, the Video Electronics Standards Association. Video graphics adapters are also called video cards, video boards, video display boards, graphics cards, and graphics adapters. In this specification, any video graphics adapter is referred generally as a ‘video graphics adapter’ or a ‘video adapter.’

Video adapters contain memory, so that the computer's RAM is not used for storing displays. In addition, most video adapters have their own graphics processor for performing graphics calculations, making the video adapter into a kind of graphics-oriented sub-computer within the larger computer in which it is installed.

Video adapters that have their own processors are often called graphics accelerators. These processors are specialized for computing graphical transformations, so they achieve better results than the general-purpose CPU used by the computer. In addition, they free up the computer's CPU to execute other commands while the graphics accelerator is handling graphics computations. The popularity of graphical applications, and especially multimedia applications, has made graphics accelerators not only a common enhancement, but a necessity. Computer manufacturers now bundle a graphics accelerator with many computer systems.

Many video adapters have their own memory, which is reserved for storing graphical representations. The amount of memory determines how much resolution and how many colors can be displayed. Some accelerators use conventional DRAM (Dynamic Random Access Memory), but others use a special type of dual-ported video RAM, which enables both the video adapter simultaneously to render image data into the memory and to access the memory for display.

Video adapters are designed for a particular type of video bus, such as the PCI bus or the AGP bus. The PCI bus is the Peripheral Component Interconnect bus, a local bus standard developed by Intel Corporation. Most modem person computers include a PCI bus in addition to a more general ISA (Industry Standard Architecture) expansion bus. PCI is also used on newer versions of the Macintosh computer. PCI is a 64-bit bus, though it is often implemented as a 32-bit bus. It can run at clock speeds of 33 or 66 MHz. At 32 bits and 33 MHz, it yields a throughput rate of 133 MBps. Although it was developed by Intel, PCI is not tied to any particular family of microprocessors.

The AGP bus is the Accelerated Graphics Port bus, an interface specification developed by Intel Corporation. AGP is based on PCI, but is designed especially for the throughput demands of 3-D graphics. Rather than using the PCI bus for graphics data, AGP introduces a dedicated point-to-point channel so that the graphics controller can directly access main memory. The AGP channel is 32 bits wide and runs at 66 MHz. This translates into a total bandwidth of 266 MBps, as opposed to the PCI bandwidth of 133 MBps. AGP also supports two optional faster modes, with throughputs of 533 MBps and 1.07 GBps. In addition, AGP allows 3-D textures to be stored in main memory rather than video memory.

A portion of memory referred to as a ‘frame buffer’ is reserved for holding the complete bit-mapped image to be sent to the monitor for display. Typically the frame buffer is stored in the memory chips on the video adapter. In some instances, however, the video chipset is integrated into the motherboard design, and the frame buffer is stored in general main memory. A bit-mapped image is a representation in digital data, describing of rows and columns of display dots, called picture elements or ‘pixels,’ of a graphics image in computer memory. The value of each pixel (whether it is filled in or not) is stored in one or more bits of data. For colors and shades of gray, each dot requires more than one bit of data. The more bits used to represent a dot, the more colors and shades of gray that can be represented. The density of the dots, known as the resolution, determines how sharply the image is represented. This is often expressed in dots per inch (dpi) or simply by the number of rows and columns, such as 640 by 480. Bit-mapped graphics are often referred to as raster graphics.

Another method for representing images is known as vector graphics or object-oriented graphics. With vector graphics, images are represented as mathematical formulas that define all the shapes in the image. Vector graphics are more flexible than bit-mapped graphics because they look the same even when scaled to different sizes. In contrast, bit-mapped graphics become ragged when shrunk or enlarged. Fonts represented with vector graphics are called scalable fonts, outline fonts, or vector fonts. A well-known example of a vector font system is PostScript. Bit-mapped fonts, also called raster fonts, must be designed for a specific device and a specific size and resolution.

In addition to the frame buffer, another portion of memory referred to as a window identification (WID) buffer, is reserved for holding WID data for each pixel. Each WID value may be used as an index to a pixel type in a window attribute table or ‘WAT.’ Examples of pixel type include pixel's of color various depths, true color pixels, color-mapped pixels, stereo pixels, and overlay pixels. A WAT may be implemented as computer memory hardware, such as a programmable read-only memory or a content addressable memory, configured as a table indexed or addressable with WID values as shown, for example, in Table 1:

TABLE 1
Window Attribute Table (WAT)

| WID Value | Window Attribute |
|---|---|
| 0 | 24 bit true color |
| 1 | 32 bit true color |
| 2 | 8 bit color index - color map 0 |
| 3 | 8 bit color index - color map 1 |
| 4 | 8 bit color index - color map 2 |
| 5 | 8 bit color index - color map 3 |
| 6 | stereo |
| 7 | overlay from overlay buffer 0 |
| 8 | overlay from overlay buffer 1 |

The left column of Table 1 contains several WID values each of which indexes or identifies a particular corresponding pixel type in the Window Attribute column. For explanation, only nine WID values are shown in Table 1, but in fact there can be any number of WID values, one for each pixel type supported by any particular graphics adapter. Each element of WID data corresponds to a particular pixel on a display screen. When rendering graphics data to video memory, a video adapter writes both bitmap data into the frame buffer and WID data into the WID buffer for each pixel, and the two must correspond. Frame buffer data contained a 24 bit color code will not display correctly if its corresponding WID data types the frame data as 8 bit color indices into a color map. It is usual in the prior art for frame data and WID data to be updated asynchronously, first one, then the other. This is common because the same hardware registers are used to hold the video adapter commands and parameter values, so that it is not possible to update the frame data and the WID data at the same time.

For further explanation of asynchronous rendering of video data to frame and WID buffers, FIG. 6 sets forth a program listing of pseudocode illustrating a prior art method of rendering images on a video graphics adapter. The example of FIG. 6 uses the general form of source code written in the C programming language, with the addition of line numbers down the left column of the listing, but the listing of FIG. 6 is referred to as ‘pseudocode’ because it is an explanation in the form of code rather than an actual program listing. In line 1 of the example of FIG. 6:
01 unsigned int *commandRegister=0x0A13CD01;

an input register of a video adapter is mapped to a memory address named ‘commandRegister.’ In lines 2 and 3 of the example of FIG. 6:

| | |
|---|---|
| 02 | #define WRITE_TO_ADAPTER(data) \ |
| 03 | {*commandRegister = (unsigned int)(data);} |

a C function named WRITE_TO_ADAPTER is defined in macro form to write video commands and parameter data to the input register of the video adapter. Lines 5-12 define eight WID values, and line 14 defines a bit mask representing the color red. Lines 17 and 18 work together to set a foreground color register on the video adapter to the color red. Line 17:
17 WRITE_TO_ADAPTER(SET_FG_COLOR);
   advises the video adapter that the next video data it receives is to be a foreground color value, and line 18:
18 WRITE_TO_ADAPTER(RED);
   delivers the bit mask for red, which the video adapter through its rendering engine places in its rendering register for foreground color. Line 21:
21 WRITE_TO_ADAPTER(FB_WE);
   through command ‘FB_WE,’ or ‘Frame Buffer Write Enable,’ directs the adapter's rendering engine to render video data to its frame buffer. Lines 24-26 taken together instruct the video adapter to render frame data for a graphics primitive, in this case, a rectangle:
24 WRITE_TO_ADAPTER(DRAW_RECT);
25 WRITE_TO_ADAPTER(0x00000000); /* x1,y1 */
26 WRITE_TO_ADAPTER(0x00640064); /* x2, y2 */
   Line 24 advises the video adapter that the next two elements of video data it receives will provide the pixel coordinates, row and column, for the bottom left corner of a rectangle and the top right corner of a rectangle respectively. Now the video adapter through its rendering engine renders into video memory, into the frame buffer, all the video color data for a red rectangle, not only the two pixels identified in the adapter commands, but color data in the frame buffer for all the pixels in the rectangle.

As just explained, lines 17-26 of the listings of FIG. 6, taken together, effectively cause video color data for a drawing primitive to be rendered to a frame buffer, lines 29-38 cause WID data for the same rectangle to be rendered to corresponding addresses in a WID buffer. Line 29:
29 WRITE_TO_ADAPTER(SET_FG_COLOR);
   advises the video adapter that the next video data it receives is to be a foreground color, and line 30:
30 WRITE_TO_ADAPTER(WID_VALUE_{—}1);
   delivers the WID value for 0x00000001, a value that indexes the second window attribute value in a window attribute table. The video adapter through its rendering engine places the value 0x00000001 in its foreground color register, using a color register to store a working WID value.
   Line 33:
32 /* Set adapter to render into WID buffer */
33 WRITE_TO_ADAPTER(WIDBUF_WE);
   through command ‘WIDBUF_WE,’ or ‘WID buffer write enable,’ directs the adapter's rendering engine to render WID data to its WID buffer. Lines 36-38 read together instruct the video adapter to render WID data for a graphics primitive, in this case, a rectangle:
36 WRITE_TO_ADAPTER(DRAW_RECT);
37 WRITE_TO_ADAPTER(0x00000000); /* x1,y1 */
38 WRITE_TO_ADAPTER(0x00640064); /* x2, y2 */
   Line 36 advises the video adapter that the next two elements of video data it receives will provide the pixel coordinates, row and column, for the bottom left corner of a rectangle and the top right corner of a rectangle respectively. Now the video adapter through its rendering engine renders into video memory, into the WID buffer, all the WID data for a rectangle having the pixel type identified by the WAT value indexed by WID_VALUE_{—}1, not only the two pixels identified in the adapter commands, but WID data in the WID buffer for all the pixels in the rectangle. If the color value for RED as rendered by lines 17-26 of the listing of FIG. 6 is of a different pixel type than is indexed by the WID data currently stored in corresponding addresses in a WID buffer, then display anomalies will occur between the time the new color data is written to the frame buffer and the time when corresponding WID data is rendered or updated by the code of lines 29-38.

When frame data is rendered for a pixel type that itself is not yet rendered, or when WID data is rendered for a pixel type whose color data has not yet been rendered to frame buffer, display anomalies occur. Is not uncommon for all the pixels on screen after screen to be of the same type, say for example, 24 bit true color. In such a case, many pixels and many screens of images may be displayed with no need to update the WID data at all. Software demands on video adapters, however, are increasing rapidly, and it is more and more often possible that pixel types will change rapidly and that more than one pixel type will be required for display on the same screen at the same time. In such a demanding video environment, there is a need for improvements in video graphics adapters to reduce the risk of display anomalies from frame data unsynchronized with its corresponding WID data.

### SUMMARY OF THE INVENTION

Methods, systems, and products are disclosed for rendering images on a video graphics adapter, including receiving in the video graphics adapter a video graphics command including a window identification (‘WID’) value and, simultaneously, in accordance with the video graphics command and in dependence upon the WID value, rendering video frame data to a frame buffer and WID data to a WID buffer. Typical embodiments also include configuring the video graphics command to include the WID value. In typical embodiments, the WID value includes an index to a pixel type in a window attribute table.

In typical embodiments, the video graphics command includes a logical WID flag and rendering video frame data to a frame buffer and WID data to a WID buffer also includes rendering the video frame data to the frame buffer without simultaneously rendering the WID data in dependence upon the WID value if the WID flag is off and simultaneously, in accordance with the video graphics command and in dependence upon the WID value, rendering video frame data to a frame buffer and WID data to a WID buffer only if the WID flag is on.

In typical embodiments, simultaneously rendering video frame data to a frame buffer and WID data to a WID buffer also includes rendering video frame data and WID data in accordance with the video graphics command and in dependence upon the WID value and simultaneously storing the video frame data in the frame buffer and the WID data in the WID buffer. In typical embodiments, simultaneously rendering video frame data to a frame buffer and WID data to a WID buffer also includes placing both video frame data and WID data on a data bus that connects to both the frame buffer and the WID buffer and strobing the video frame data into the frame buffer and the WID data into the WID buffer, both on the same clock transition.

In typical embodiments, the frame buffer includes a video memory bearing pixel color data in memory locations mapped to all pixels of a computer display screen, the WID buffer comprises a video memory bearing WID data for the pixels in memory locations mapped to all the pixels of the computer display screen, the WID data comprising indices to pixel types in a window attribute table, and the pixel color data and the WID data for each pixel are stored at the same memory address respectively in the frame buffer and in the WID buffer. In typical embodiments, the video graphics command includes a command to the video graphics adapter to render a drawing primitive and rendering video frame data to a frame buffer and WID data to a WID buffer also includes rendering the video frame data and the WID data for the drawing primitive.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery useful in rendering images on a video graphics adapter.

FIG. 2 sets forth a block diagram of an exemplary video adapter for rendering images.

FIG. 3 sets forth a timing diagram illustrating an exemplary timing sequence.

FIG. 4 sets forth an exemplary video graphics command useful for rendering images on a video graphics adapter.

FIG. 5 sets forth a flow chart of an exemplary method for rendering images on a video graphics adapter.

FIG. 6 sets forth a program listing of pseudocode illustrating a prior art method of rendering images on a video graphics adapter.

FIG. 7 sets forth a program listing of pseudocode illustrating a method of rendering images on a video graphics adapter.

### DETAILED DESCRIPTION OF EXEMPLARY EMBODIMENTS

### Introduction

The present invention is described to a large extent in this specification in terms of methods for rendering images on a video graphics adapter. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Rendering Images on a Video Graphics Adapter

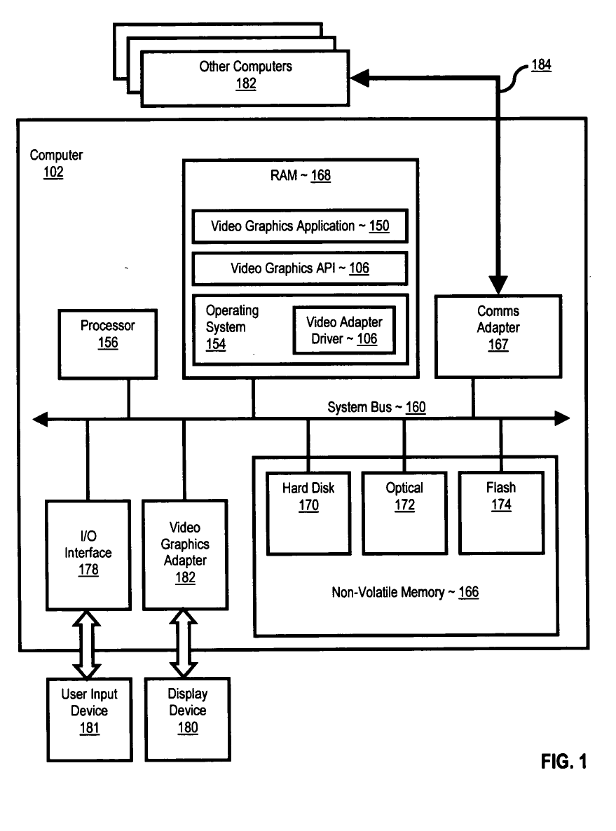

Rendering images on a video graphics adapter in accordance with the present invention is generally implemented with computers, that is, with automated computing machinery. For further explanation, FIG. 1 sets forth a block diagram of automated computing machinery comprising a computer (102) useful in rendering images on a video graphics adapter according to embodiments of the present invention. The computer (102) of FIG. 1 includes at least one computer processor (156) or ‘CPU’ as well as random access memory (168) (“RAM”). Stored in RAM (168) is a video graphics application (150), a software program that uses a video graphics application programming interface (API) to provide video commands and video data to a video graphics adapter. A video graphics application may be any software program that displays images on a computer display screen including, for example, word processing programs, spreadsheet programs, email programs, browsers, and so on, as will occur to those of skill in the art. A video graphics API, implemented to render images on a video graphics adapter according to embodiments of the present invention and recorded on a recording medium, is a particular example of a computer program product according to embodiments of the present invention.

Examples of video graphics APIs that may be implemented or improved for rendering images on video graphics adapters according to embodiments of the present invention include OpenGL, Direct3D, and graPHIGS. OpenGL is a graphics language developed by Silicon Graphics. There are two main implementations: Microsoft OpenGL, developed by Microsoft, and Cosmo™ OpenGL, developed by Silicon Graphics. Microsoft OpenGL is built into the Microsoft operating system Windows NT™ and is designed to improve performance on hardware that supports the OpenGL standard. Cosmo OpenGL, on the other hand, is a software-only implementation specifically designed for machines with video adapters that provide little or no advanced support for video graphics.

Direct3D is an API for manipulating and displaying three-dimensional objects developed by Microsoft. Direct3D provides programmers with a way to develop programs that can utilize whatever video adapter device is installed in a particular computer. Virtually all 3-D accelerator cards for personal computers support Direct3D.

The graPHIGS API is based on the American National Standards Institute (ANSI) and International Standard Organization (ISO) standard called Programmer's Hierarchical Interactive Graphics System (PHIGS). The graPHIGS API provides programmers with the capability to design and code graphics applications that take advantage of high-function graphics devices, that is, video adapters with advanced video acceleration capabilities. The graPHIGS API decides itself whether to use local video processing on a video adapter or to have a computer CPU do the video processing for a less workstations with a less powerful video adapter.

Also stored in RAM (168) is an operating system (154). The operating system provides an interface used by applications and graphics APIs to access computer resources, including a calling interface provided through a video adapter driver (106) to access video graphics adapters with commands and parameter data. Operating systems useful in computers according to embodiments of the present invention include Unix™, Linux™, AIX™, Microsoft Windows NT™, and many others as will occur to those of skill in the art. Operating system (154) in the example of FIG. 1 is shown in RAM (154), but many components of an operating system may be stored in non-volatile memory (166) also.

The computer (102) of FIG. 1 includes non-volatile computer memory (166) coupled through a system bus (160) to processor (156) and to other components of the computer storing a plurality of available browsers (405). System bus (160) may be a PCI bus, an AGP bus, an ISA bus, or others that may occur to those of skill in the art. Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary computer (102) of FIG. 1 includes a communications adapter (167) for implementing connections for data communications (184), including connections through networks, to other computers (182), including servers, clients, and others as will occur to those of skill in the art. Communications adapters implement the hardware level of connections for data communications through which local devices and remote devices or servers send data communications directly to one another and through networks. Examples of communications adapters useful for rendering images on a video graphics adapter according to embodiments of the present invention include modems for wired dial-up connections, Ethernet (IEEE 802.3) adapters for wired LAN connections, and 802.11b adapters for wireless LAN connections.

The example computer of FIG. 1 includes one or more input/output interface adapters (178, 182). Input/output interface adapters in computers implement user-oriented input/output through, for example, software drivers and computer hardware, such as video graphics adapter (182), for controlling output to display devices (180) such as computer display screens, as well as user input from user input devices (181) such as keyboards and mice.

In the example of FIG. 1, video graphics adapter (182) is configured to render images according to embodiments of the present invention by receiving in the video graphics adapter (182) a video graphics command that includes including a WID value and, simultaneously, in accordance with the video graphics command and in dependence upon the WID value, render video frame data to a frame buffer and WID data to a WID buffer.

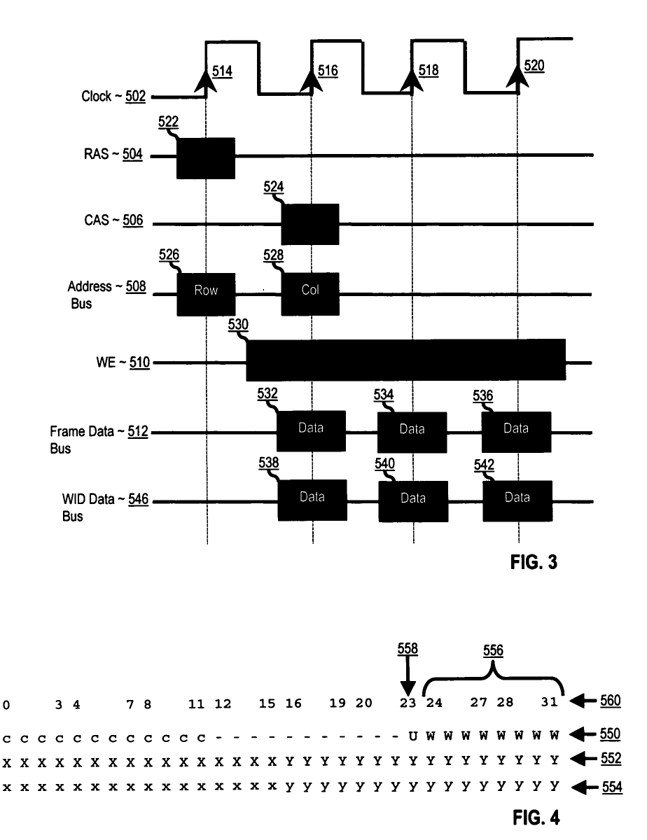

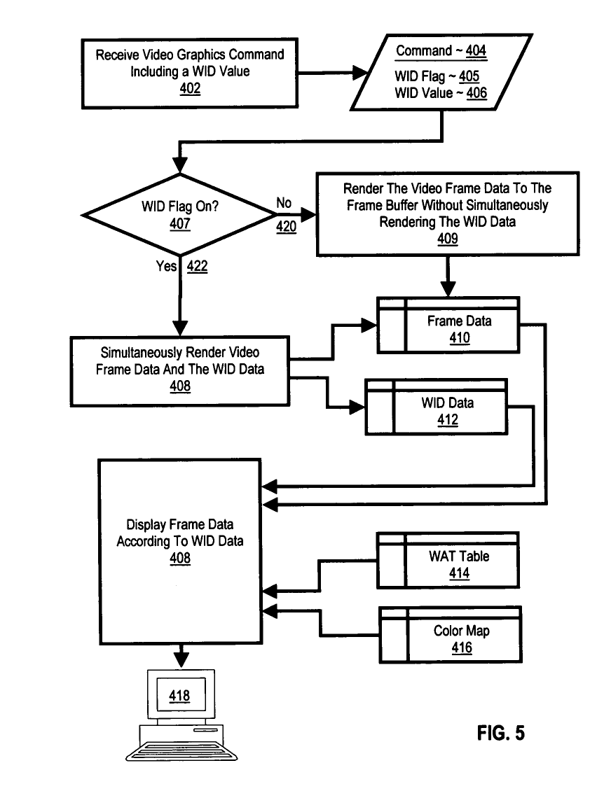

The video graphics command is configured to include the WID value so that a rendering engine in the video graphics adapter can use it to render WID data to a WID buffer. For further explanation of the video graphics command, FIG. 4 sets forth an exemplary video graphics command useful for rendering images on a video graphics adapter according to embodiments of the present invention. The example video graphics command of FIG. 4 includes three command lines (550, 552, 554). Each command line is digital data, a 32-bit binary word represented with bits numbered from left to right, 0 through 31 (560). Command lines (552, 554) are configured for parameter data. They may, for example, contain pixel location data defining for a graphics adapter a drawing primitive such as two corner points for a rectangle. Command line (550), in its leftmost bits, set forth a command code instructing a video graphics adapter to take some action for rendering an image. Such a command code may, for example, instruct a video adapter to render a rectangle having bottom left corner and top right corner at the pixel locations identified in command lines (552, 554).

Command line (550), in its rightmost bits, bits 23-31, incorporates an 8-bit WID value in bits 24-31 (556) and a one-bit WID flag in bit 23 (558). As mentioned, the WID value is an index to a pixel type in a window attribute table. The WID flag is treated by a rendering engine in a video graphics adapter to indicate whether the rendering engine is to use the WID value to render WID data simultaneously with frame data. That is, if the WID flag is off, a 0 or a logical FALSE, then the video adapter renders the video frame data to the frame buffer without simultaneously rendering the WID data; the WID is still rendered, but it is rendered before the frame data or after the frame data, not simultaneously.

If the WID flag is on, that is, contains a 1 or is logically set to TRUE, then the video graphics adapter simultaneously renders video frame data to a frame buffer and WID data to a WID buffer. In a video adapter (182 on FIG. 1) that renders images according to embodiments of the present invention, the frame buffer may be implemented as a video memory bearing pixel color data in memory locations mapped to all pixels of a computer display screen, the WID buffer may be implemented as a video memory bearing WID data for the pixels in memory locations mapped to all the pixels of the computer display screen, and the pixel color data and the WID data for each pixel are stored at the same memory address respectively in the frame buffer and in the WID buffer. In such a video adapter, simultaneously rendering video frame data to a frame buffer and WID data to a WID buffer may be carried out by rendering video frame data as instructed in a video graphics command, rendering WID data using a WID value provided in the graphics command, and simultaneously storing the video frame data in the frame buffer and the WID data in the WID buffer. That is simultaneously rendering video frame data to a frame buffer and WID data to a WID buffer may be carried out by placing both video frame data and WID data on a data bus that connects to both the frame buffer and the WID buffer and strobing the video frame data into the frame buffer and the WID data into the WID buffer, both on the same clock transition.

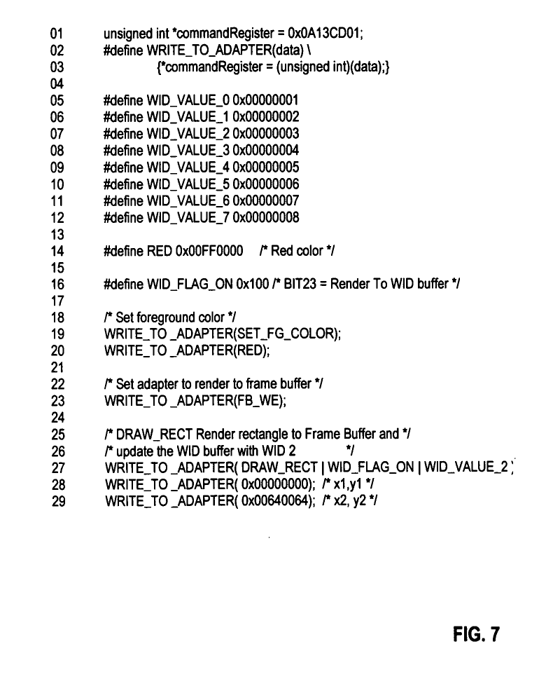

Rather than taking the time to make a system call through video adapter driver (106 on FIG. 1) to deliver commands and video data to video graphics adapter (182), video graphics API (106) may write video commands and data directly to a memory address mapped to one or more input registers on video graphics adapter (182), a much faster process. For further explanation of simultaneous rendering of video data to a frame buffer and to a WID buffer, FIG. 7 sets forth a program listing of pseudocode illustrating a method of rendering images on a video graphics adapter according to embodiments of the present invention. The example of FIG. 7 uses the general form of source code written in the C programming language, with the addition of line numbers down the left column of the listing, but the listing of FIG. 7 is referred to as ‘pseudocode’ because it is an explanation in the form of code rather than an actual program listing. In line 1 of the example of FIG. 7:
01 unsigned int *commandRegister=0x0A13CD01;

an input register of a video adapter is mapped to a memory address named ‘commandRegister.’ In lines 2 and 3 of the example of FIG. 7:

| | |
|---|---|
| 02 | #define WRITE_TO_ADAPTER(data) \ |
| 03 | {*commandRegister = (unsigned int)(data);} |

a C function named WRITE_TO_ADAPTER is defined in macro form to write video commands and parameter data to the input register of the video adapter.

Lines 5-12 define eight WID values, and line 14 defines a bit mask representing the color red. Line 16 defines a bit mask named WID_FLAG_ON for a WID flag in bit 23 of a video command. The WID flag WID_FLAG_ON may be logically ORed with the video command to turn the WID flag on, that is, set the WID flag to 1 or logical TRUE.

Lines 19 and 20 work together to set a foreground color register on the video adapter to the color red. Line 19:
19 WRITE_TO_ADAPTER(SET_FG_COLOR);
   advises the video adapter that the next video data it receives is to be a foreground color value, and line 20:
20 WRITE_TO_ADAPTER(RED);
   delivers the bit mask for red, which the video adapter through its rendering engine places in its rendering register for foreground color. Line 23:
23 WRITE_TO_ADAPTER(FB_WE);

through command ‘FB_WE,’ or ‘Frame Buffer Write Enable,’ directs the adapter's rendering engine to render video data to its frame buffer. Lines 27-29 taken together instruct the video adapter to render, simultaneously, frame data for a graphics primitive, in this case, a rectangle, and WID data for the same rectangle to be rendered to the same addresses in a WID buffer:

| | |
|---|---|
| 27 | WRITE_TO_ADAPTER\ |
| | ( DRAW_RECT \| WID_FLAG_ON \| WID_VALUE_2 ); |
| 28 | WRITE_TO_ADAPTER(0x00000000); /* x1,y1 */ |
| 29 | WRITE_TO_ADAPTER(0x00640064); /* x2, y2 */ |

In Line 27, the DRAW_RECT command code instructs the video adapter to render a rectangle and advises the video adapter that the next two elements of video data it receives will provide the pixel coordinates, row and column, for the bottom left corner of the rectangle and the top right corner of the rectangle respectively. DRAW_RECT is logically ORed with WID_FLAG_ON and with WID_VALUE_{—}2, advising the video adapter that it is to simultaneously render both frame data and WID data for the rectangle and that the WID value of 2 is to be used to render the WID data. The video adapter through its rendering engine renders into video memory, into the frame buffer, all the video color data for a red rectangle, not only the two pixels identified in the adapter commands, but color data in the frame buffer for all the pixels in the rectangle.

The video adapter through its rendering engine, with no need for a separate or additional command to do so, also renders into a WID buffer all the WID data for the rectangle, not merely the two pixels identified in the adapter commands, but WID data in the WID buffer for all the pixels in the rectangle. In this example, the foreground color register is already occupied by the foreground color code for red. So the video adapter stores WID_VALUE_{—}2 in a separate register. The video adapter may render the frame data and WID data simultaneously by calculating a color value for a pixel, assigning WID_VALUE_{—}2 as the WID value for the same pixel, placing the color value on a data bus connected to the frame buffer, placing the WID value on a data bus connected to a WID buffer, and strobing the exact same memory address on the memory address lines at the same time for both buffers so that the frame data and the WID data are stored at the same memory address in both buffers on the same clock transitions.

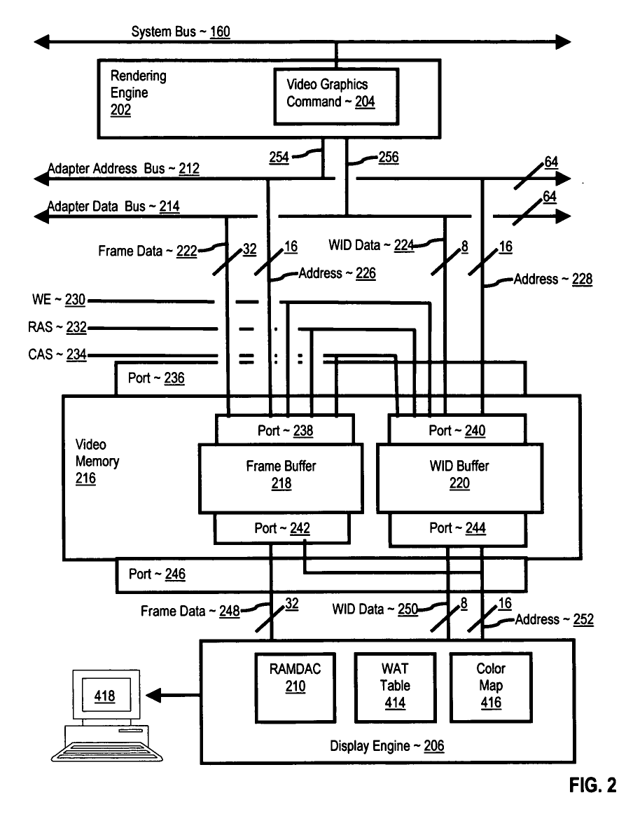

For further explanation, FIG. 2 sets forth a block diagram of an exemplary video adapter for rendering images according to embodiments of the present invention. The video adapter of FIG. 2 includes a rendering engine. A rendering engine is a computer module, a combination of computer hardware and software, that may be implemented as a video processor which may be a general purpose computer processor programmed to render images according to embodiments of the present invention or may be a special purpose video processor completely hardwire or anything in between as will occur to those of skill in the art. In the example of FIG. 2, the rendering engine contains a video graphics command (204) received from system bus (160) that instructs the rendering engine to render a pixel or a graphics primitive according to embodiments of the present invention. System bus (160) may be a PCI bus, an AGP bus, an ISA bus, or another bus that may occur to those of skill in the art. The video graphics command (204) is implemented as described above to include a WID value and a WID flag. Rendering engine (202) drives output (256) of frame data and WID data onto data bus (214), output (254) of memory address data onto address bus (212).

Rendering engine (202) also provides control signals for memory control lines Write Enable (230), Row Address Strobe (232), and Column Address Strobe (234). These and other control lines may oriented in an instruction bus, and all devices on the video adapter may be driven by a system clock (not shown). The video adapter of FIG. 2 includes a video memory module (216) with a 32-bit memory address space supplied by a 16-bit memory address bus, two sets of the same 16 memory address lines (226, 228) connected respectively to the frame buffer (218) and the WID buffer (220). In this example, the buffers (218, 220) are explained as DRAM, and DRAM is typically addressed in rows and columns, not to be confused with screen row and column locations for pixels. Rendering engine (202) maps pixel locations to DRAM addresses. Row and column DRAM addresses may be strobed and clocked into the memory module separately, first the row address, then the column address, each limited in this example to no more than 16 bits. As a practical matter, DRAMs use row addresses to refresh memory content and are therefore typically implemented with fewer rows than columns—to make refresh more efficient. So as a practical matter, memory module (216) may be implemented to use less than the 16 available address bus bits for its row addresses.

The video adapter of FIG. 2 includes a video memory module (216) that includes a frame buffer (218) and a WID buffer (220). The buffers are dual-ported (238, 242, 240, 244) and may be implemented with two or more Video DRAM (VDRAM) or Windows DRAM (WDRAM) integrated circuits—or with other DRAM chips as will occur to those of skill in the art. The use of dual-ported DRAM in this example is for ease of explanation, not a limitation of the present invention. A video memory module for rendering images in a video adapter according to embodiments of the present invention may also be implemented with single-ported DRAM chips, for example, and with other memory chips as will occur to those of skill in the art.

In the example of FIG. 2, video memory module (216) is dual-ported (236, 248). Video memory (216) in fact includes four internal ports (238, 242, 240, 244). The four internal ports, however, are so oriented to the adapter buses that they present the appearance of two ports to other devices on the video adapter. That is, ports (238, 240) both connect on the rendering side, for example, to the same 16 address bus lines (226, 228) and both take data inputs from the same set of data bus lines (214), although not from exactly the same data lines. Port (238) connects to a set of data lines (222) containing frame data from the rendering engine (202), while port (240) connects to another set of data lines (224), from the same data bus (214), containing WID data from the rendering engine.

The video adapter of FIG. 2 also includes a display engine (206). The display engine (206) connects to the video memory through a 16 bit address bus (252), a 32 bit frame data bus (248), an 8 bit WID data bus, and control lines for RAS, CAS, and so on (not shown). As illustrated, frame data and WID data are clocked out of the memory module as parallel words on a data bus. Alternatively external port (246) may be configured with internal ports (242, 244) to provide serial streams of digital data from the frame buffer (218) and the WID buffer (220). The display engine (206) includes a color map (416) that frame data values to color values for indexed pixel colors, a WAT table (414) that indexes window attribute values to WID values, and a RAMDAC or Random Access Memory Digital to Analog Converter that accepts digital color values from frame data, window attributes derived from WID data, and produces a video signal for output to a display screen (418).

For further explanation of simultaneously rendering video frame data to a frame buffer and WID data to a WID buffer, FIG. 3 sets forth a timing diagram illustrating an exemplary timing sequence among an address bus, a data bus, and control lines of a video memory module, such as the one illustrated for example at reference (216) on FIG. 2, in a video adapter for rendering images according to embodiments of the present invention. The timing diagram of FIG. 3 is for a DRAM that accepts a clock signal (502) from a clock line on a video adapter and changes states on the rising transitions (513, 516, 518, 520) of the clock signal. In time for clock transition (514), a row address (526) is placed on address bus (508), and Row Address Strobe (504) is activated (522). The row address (626) is strobed into video memory on rising clock transition (514). A column address (528) is placed on address bus (508), and Column Address Strobe (506) is activated (524). The column address (528) is strobed into video memory on rising clock transition (516).

The same row and column address are provided within the video memory to both a frame buffer and a WID buffer. When both row address and column address are strobed in, video memory then has a complete memory address for a cell of DRAM, actually two cells in this case, one in a frame buffer and one in a WID buffer. A cell of DRAM may contain one or more bits of memory, typically more than one. Several DRAM chips may be addressed in parallel to establish any desired cell size. The cell size need not be the same in the frame buffer as in the WID buffer. The frame buffer may conveniently use 32 bit cells, for example, to store 32 bit color code, while the WID buffer may conveniently use 8 bit DRAM cells to store 8 bits of WID data per cell. Either way, both the frame buffer and the WID buffer have a cell activated now at exactly the same address in both buffers. The address in question is a memory address, not a pixel display location. The memory address is mapped to the pixel display location by a rendering engine and a display engine.

Before clock transition (516), frame data (532) is placed on the frame data bus (512) and WID data (538) is placed on the WID data bus (546). As explained above, frame data bus (512) and WID data bus (546) may be implemented as separate data lines from the same larger data bus. Write Enable (510) is activated (530). On clock transition (516), the subject video memory module has complete address data, an active Write Enable signal, and valid data on its data bus. On clock transition (516), therefore, the video memory operating according to the example timing sequence of FIG. 3 simultaneously stores both the frame data (532) on its frame data bus (512) and the WID data (538) on its WID data bus (546), thereby simultaneously rendering video frame data to a frame buffer and WID data to a WID buffer. In addition, a video memory module operating as illustrated in FIG. 3 may also accept additional frame data (534, 536) and additional WID data (540, 542) in bursts during a single write cycle, thereby storing more than one set of frame data and more than one set of WID data in each memory write cycle, leaving the row address (526) constant during the write cycle and automatically incrementing its column address (528) internally for each additional burst of data written during the write cycle. Each such additional burst of data represents an additional simultaneous rendering of video frame data to a frame buffer and WID data to a WID buffer.

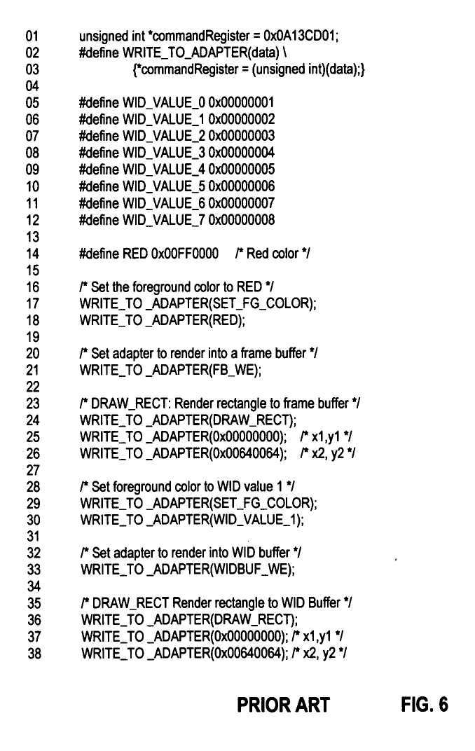

For further explanation, FIG. 5 sets forth a flow chart of an exemplary method for rendering images on a video graphics adapter according to embodiments of the present invention. The method of FIG. 5 includes receiving (402) in a video graphics adapter a video graphics command (404) that includes a WID value (406). The method of FIG. 5 also includes simultaneously, in accordance with the video graphics command and in dependence upon the WID value, rendering (408) video frame data (410) to a frame buffer and WID data (412) to a WID buffer. In the method of FIG. 3, the video graphics command may be a command to the video graphics adapter to render a drawing primitive, and rendering (408) video frame data to a frame buffer and WID data to a WID buffer further comprises rendering the video frame data and the WID data for the drawing primitive. That is, rendering the frame data and the WID data may include rendering frame data and WID data for one pixel or for more than one pixel in response to a single video graphics command.

In the method of FIG. 3, the video graphics command (405) includes a logical WID flag (405), and rendering video frame data to a frame buffer and WID data to a WID buffer is carried out by rendering (409) the video frame data to the frame buffer without simultaneously rendering the WID data in dependence upon the WID value if the WID flag is off (420). The illustrated method also includes simultaneously, in accordance with the video graphics command and in dependence upon the WID value, rendering (408) video frame data to a frame buffer and WID data to a WID buffer only if the WID flag is on (422).

In the method of FIG. 3, simultaneously rendering (408) video frame data to a frame buffer and WID data to a WID buffer may be carried out by rendering video frame data and WID data in accordance with the video graphics command and in dependence upon the WID value and simultaneously storing the video frame data in a frame buffer and the WID data in a WID buffer. In the method of FIG. 3, simultaneously rendering (408) video frame data to a frame buffer and WID data to a WID buffer may be carried out by placing both video frame data and WID data on a data bus that connects to both a frame buffer and a WID buffer and strobing the video frame data into the frame buffer and the WID data into the WID buffer, both on the same clock transition. The frame buffer may be video memory bearing pixel color data as frame data in memory locations mapped to all pixels of a computer display screen. The WID buffer may be a video memory bearing WID data for the pixels in memory locations mapped to all the pixels of the computer display screen, where the WID data represents indices to pixel types or ‘window attributes’ stored in a window attribute table. In the example of FIG. 3, the pixel color data, that is, the frame data (410) and the WID data (412) for each pixel are stored at the same memory address respectively in a frame buffer and in a WID buffer.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for rendering images on a video graphics adapter, the method comprising:
receiving in the video graphics adapter a video graphics command including a window identification (‘WID’) value; and
simultaneously, in accordance with the video graphics command and in dependence upon the WID value, rendering video frame data to a frame buffer and WID data to a WID buffer.

2. The method of claim 1 further comprising configuring the video graphics command to include the WID value.

3. The method of claim 1 wherein the WID value comprises an index to a pixel type in a window attribute table.

4. The method of claim 1 wherein the video graphics command includes a logical WID flag and rendering video frame data to a frame buffer and WID data to a WID buffer futher comprises:
rendering the video frame data to the frame buffer without simultaneously rendering the WID data in dependence upon the WID value if the WID flag is off; and
simultaneously, in accordance with the video graphics command and in dependence upon the WID value, rendering video frame data to a frame buffer and WID data to a WID buffer only if the WID flag is on.

5. The method of claim 1 wherein simultaneously rendering video frame data to a frame buffer and WID data to a WID buffer further comprises:
rendering video frame data and WID data in accordance with the video graphics command and in dependence upon the WID value; and
simultaneously storing the video frame data in the frame buffer and the WID data in the WID buffer.

6. The method of claim 1 wherein simultaneously rendering video frame data to a frame buffer and WID data to a WID buffer further comprises:
placing both video frame data and WID data on a data bus that connects to both the frame buffer and the WID buffer; and
strobing the video frame data into the frame buffer and the WID data into the WID buffer, both on the same clock transition.

7. The method of claim 1 wherein:
the frame buffer comprises a video memory bearing pixel color data in memory locations mapped to all pixels of a computer display screen,
the WID buffer comprises a video memory bearing WID data for the pixels in memory locations mapped to all the pixels of the computer display screen, the WID data comprising indices to pixel types in a window attribute table; and
the pixel color data and the WID data for each pixel are stored at the same memory address respectively in the frame buffer and in the WID buffer.

8. The method of claim 1 wherein:
the video graphics command comprises a command to the video graphics adapter to render a drawing primitive, and
rendering video frame data to a frame buffer and WID data to a WID buffer further comprises rendering the video frame data and the WID data for the drawing primitive.

9. A system for rendering images on a video graphics adapter, the system comprising:
means for receiving in the video graphics adapter a video graphics command including a window identification (‘WID’) value; and
means for simultaneously rendering video frame data to a frame buffer and WID data to a WID buffer in accordance with the video graphics command and in dependence upon the WID value.

10. The system of claim 9 further comprising means for configuring the video graphics command to include the WID value.

11. The system of claim 9 wherein the WID value comprises an index to a pixel type in a window attribute table.

12. The system of claim 9 wherein the video graphics command includes a logical WID flag and means for simultaneously rendering video frame data to a frame buffer and WID data to a WID buffer further comprises:
means for rendering the video frame data to the frame buffer without simultaneously rendering the WID data if the WID flag is off; and
means for simultaneously rendering video frame data to a frame buffer and WID data to a WID buffer, in accordance with the video graphics command and in dependence upon the WID value, only if the WID flag is on.

13. The system of claim 9 wherein means for simultaneously rendering video frame data to a frame buffer and WID data to a WID buffer further comprises:
means for placing both video frame data and WID data on a data bus that connects to both the frame buffer and the WID buffer; and
means for strobing the video frame data into the frame buffer and the WID data into the WID buffer, both on the same clock transition.

14. The system of claim 9 wherein:
the frame buffer comprises a video memory bearing pixel color data in memory locations mapped to all pixels of a computer display screen,
the WID buffer comprises a video memory bearing WID data for the pixels in memory locations mapped to all the pixels of the computer display screen, the WID data comprising indices to pixel types in a window attribute table; and
the pixel color data and the WID data for each pixel are stored at the same memory address respectively in the frame buffer and in the WID buffer.

15. A computer program product for rendering images on a video graphics adapter, the computer program product comprising:
a recording medium;
means, recorded on the recording medium, for receiving in the video graphics adapter a video graphics command including a window identification (‘WID’) value; and
means, recorded on the recording medium, for simultaneously rendering video frame data to a frame buffer and WID data to a WID buffer in accordance with the video graphics command and in dependence upon the WID value.

16. The computer program product of claim 15 further comprising means, recorded on the recording medium, for configuring the video graphics command to include the WID value.

17. The computer program product of claim 15 wherein the WID value comprises an index to a pixel type in a window attribute table.

18. The computer program product of claim 15 wherein the video graphics command includes a logical WID flag and means, recorded on the recording medium, for simultaneously rendering video frame data to a frame buffer and WID data to a WID buffer further comprises:
means, recorded on the recording medium, for rendering the video frame data to the frame buffer without simultaneously rendering the WID data in dependence upon the WID value if the WID flag is off; and
means, recorded on the recording medium, for simultaneously rendering video frame data to a frame buffer and WID data to a WID buffer, in accordance with the video graphics command and in dependence upon the WID value, only if the WID flag is on.

19. The computer program product of claim 15 wherein means, recorded on the recording medium, for simultaneously rendering video frame data to a frame buffer and WID data to a WID buffer further comprises:
means, recorded on the recording medium, for placing both video frame data and WID data on a data bus that connects to both the frame buffer and the WID buffer; and
means, recorded on the recording medium, for strobing the video frame data into the frame buffer and the WID data into the WID buffer, both on the same clock transition.

20. The computer program product of claim 15 wherein:
the frame buffer comprises a video memory bearing pixel color data in memory locations mapped to all pixels of a computer display screen,
the WID buffer comprises a video memory bearing WID data for the pixels in memory locations mapped to all the pixels of the computer display screen, the WID data comprising indices to pixel types in a window attribute table; and
the pixel color data and the WID data for each pixel are stored at the same memory address respectively in the frame buffer and in the WID buffer.
